(19) United States
(12) Patent Application Publication
(10) Pub. No.: US 2005/0259151 A1
(43) Pub. Date: Nov. 24, 2005

(54) Incident recording information transfer device

(76) Inventors: Jeffrey A. Hamilton, Centennial, CO (US); Robert Jeffrey Scaman, Highlands Ranch, CO (US)

Correspondence Address: THE MCCALLUM LAW FIRM, LLC, 132 KOLAR COURT, ERIE, CO, 80516, US

(21) Appl. No.: 10/662,182

(22) Filed: Sep. 12, 2003

Related U.S. Application Data
(63) Continuation of application No. 09/758,645, filed on Jan. 10, 2001.
Application No. 09/758,645 is a continuation-in-part of application No. 09/088,267, filed on Jun. 1, 1998, now abandoned.
Application No. 09/758,645 is a continuation-in-part of application No. 09/327,828, filed on Jun. 8, 1999, now Pat. No. 6,211,907.

(51) Int. Cl. H04N 7/18

(52) U.S. Cl. 348/148; 340/436

(57) ABSTRACT

A novel device for remote information download and transfer for downloading a secure, permanent record of criminal activity and/or accident evidence relating to a vehicle for evidentiary purposes which may be directly transferred to an information center and/or the authorities through a transmission link which is preferably a satellite up/link-down/link or saved directly onto the downloading device. The remote downloading device may be activated automatically or upon a trigger signal and comprises an interface, an information capturing storage device, a video monitor display and preferably a transceiver. The interface communicates with an information storage device, downloads the information saved therein and transmits it to the capture storage device, transceiver or both. The information may be displayed on the visual display monitor or transmitted via the transceiver to an off site location.

### BACKGROUND OF THE INVENTION

1. Field of the Invention

The present application is a Continuation-in-Part of parent application Ser. No. 9/088,267 filed Jun. 1, 1998, for a “Secure, Vehicle Mounted, Incident Recording System” and a Continuation-in-Part of application Ser. No. 09/327,828 filed Jun. 8, 1999 for a “Secure, Vehicle Mounted, Surveillance System”. The parent application, which is incorporated by reference in its entirety, discloses an on-board, vehicle incident recording system for producing a secure, permanent record of vehicular accidents for evidentiary purposes and downloading the permanent record through on site or remote means such as through a wireless transmission.

The continuation-in-part application, which is incorporated by reference in its entirety, discloses an on-board, vehicle surveillance system for producing a secure, permanent record of criminal activity relating to the vehicle for evidentiary purposes which may be transferred directly to an information center and/or the authorities via a transmission link which is preferably a satellite up/link-down/link.

The instant invention is broadly directed to an on-board, vehicle surveillance system; and, more particularly, to a remote information download and transfer device for downloading a secure, permanent record of criminal activity and/or accident evidence for evidentiary purposes.

2. Related Art

Vehicle insurance carriers are continually looking for ways to reduce losses as well as the cost associated with handling claims. In our prior applications, we addressed the losses associated with vehicular mishaps and vehicular vandalism and/or theft. Each year there are over 35 million on-the-road accidents in the United States alone. There are many other vehicles, including water craft, and off-road vehicles, which also are involved in mishaps. These can vary from one vehicle to multi-vehicle incidents. These mishaps or accidents cause billions of dollars of property and personal injury damage every year. In most cases, one or more of the parties is at fault, and law enforcement officers, insurance adjusters, and the like are required to find credible witnesses to re-account the factual evidence so that culpability and liability may be accurately determined.

Likewise, each year, theft and vandalism of vehicles account for losses that approach the magnitude of those resulting from accidents. These also are insured losses that must be handled by insurance carriers. In many cases, however, the loss either is caused by carelessness or is in fact an “inside job.” The insurance industry, which is responsible for investigation and replacement or coverage of the losses, spends millions of dollars investigating such activity, as well as billions of dollars in replacing or compensating policy holders for avoidable losses.

In both of the above scenarios, the recording, storage, and remote access of information relating to the events of an accident or theft which later can be used as reliable evidence would be very beneficial in both stream lining accident and vehicle claims and ensuring that only valid claims are compensated. Further, having remote access to this information and the ability to download it off site would be useful in, for example, expediting the investigation of an accident or theft, providing accurate medical attention in the event of an accident, assisting in the apprehension of perpetrators, and locating and retrieving stolen vehicles.

With respect to the Secure, Vehicle Mounted, Incident Recording System, the ability to download the secure information to a permanent off site location is particularly helpful in expediting insurance claims because the adjuster's presence at the scene of the accident is not required, nor would the adjuster be required to analyze the damaged vehicle in order to ascertain fault. Instead, the information downloaded from the Secure, Vehicle Mounted, Incident Recording System could be reviewed easily and quickly and a determination of fault could be made. Further, it would be helpful if the authorities, rescue workers, hospitals, and the like could download the information en route to an accident scene, or at the scene itself, in order to ascertain the extent of the damage, fault, the equipment required (i.e., tow truck, jaws of life, etc), and the extent and cause of any injuries.

It therefore would be advantageous to have a remote device that could access, remotely or on site, the information being generated and/or securely stored on the Secure, Vehicle Mounted Incident Recording System (hereinafter, the “Recording System”), download that information, and instantaneously transmit the information via a transceiver to authorities, rescue vehicles, hospitals, and/or to an off site storage location. Thus, the transmission could be real time or delayed. Further, it would be advantageous to have a device that incorporated a video output interface to a display screen monitor such that a police officer, rescue unit, hospital, or the like actually could view the incident in order to provide better assistance. It would also be advantageous to have a device that, in addition to video output display, could download, transmit, and display information regarding certain physical phenomenon associated with a vehicular accident or theft, such as vehicle dynamic information including position, speed, and acceleration, and also audio, and the like, that had been monitored and recorded by the Recording System and could be utilized by police, hospitals, rescue workers, and the like in ascertaining certain information, such as the extent of any injuries, determination of fault in an accident, whether a crime is ongoing, and the proper equipment needed for a particular incident.

### SUMMARY OF THE INVENTION

A remote information access and transfer device for accessing, receiving and/or downloading information from a Recording System, and transmitting the information to a remote station or storage facility has now been discovered. The invention broadly contemplates an off-board downloading device for accessing information on a Recording System and for viewing and/or transferring that information to an off site location. The remote information access and transfer device of the present invention is capable of accessing a remotely located Recording System and downloading information to the remote information access and transfer device from the Recording System either instantaneously or upon up-link command. The information can be downloaded from the Recording System in a variety of ways, including instantaneously, at various set intervals, in response to certain events, and/or in response to remote commands. The information on the Recording System can be accessed by the device either in real time, as the incident is being recorded, or after the incident has been recorded and stored on the Recording System.

For the purpose of clarity, this description is directed to use of the remote information access and transfer device with a single Recording System. The remote information access and transfer device of the instant invention, however, can function equally well with either a single Recording System or with a multiplicity of Recording Systems, as one possessing ordinary skill in the art appreciates.

In the broad aspect, the remote information access and transfer device of the instant invention comprises a portable computer system having information input means for entering commands and information used in accessing and communicating with a remote Recording System; and a transceiver for receiving, downloading, and transmitting information from a Recording System. In one embodiment, the device further comprises a visual display for viewing information downloaded from a Recording System. In another embodiment, the device further comprises information storage means for storing information downloaded from a Recording System. The device can be free-standing or mounted in a vehicle, such as a police car or other rescue vehicle for example, or can be utilized from a stationary facility, such as a hospital, a police station, or an insurance company office for example, for downloading, viewing, and instantly transmitting the downloaded information to a secure, off-site location.

In a preferred embodiment, the device is capable of downloading both secure, encrypted information and non-encrypted information for real time viewing and/or transmitting and storing the downloaded information at an off site location. To enable real time viewing of the downloaded information, the device has an off board video output interface to display the incident that is downloaded on a display screen or monitor, thereby providing certain physical and/or dynamic information, such as the orientation, position, speed, and acceleration of a vehicle, the location of vehicles and/or people, impact parameters, information regarding the positions of the vehicle controls such as brakes, gears, steering wheels, lights, windshield wipers, and the like, that may facilitate investigation of the incident. The device further is capable of downloading and playing back audio information associated with incidents recorded and stored by a Recording System.

In a preferred aspect, the remote downloading device has at least one transceiver for accessing, downloading, and remotely transmitting information to an off site location, such as a base station, a hospital, an insurance company, law enforcement, a rescue vehicle, or the like. The transceiver receives signals from a remote unit, such as a Recording System, which allows the device to transmit recorded and/or stored information directly from the safe box or hard drive located on the Recording System to an off site location and/or instantaneously as it is generated. The transmitter may transmit the information via tower, radio wave, satellite bandwidth, or the like. In an effort to protect the integrity of the transmitted information, the transceiver is located upstream of the Recording System safe box or hard drive, and the downloaded information is transmitted simultaneously to an off site location. Thus, the transceiver on the device communicates directly with the Recording System to transmit the information to an off site location as the information is being downloaded to the device and prior to the user being able to view the information via the display screen. This also allows for the information to be transmitted to the remote location and viewed in real time. The device is triggered to download and transmit information or information from a Recording System in a variety of ways, such as, for example, on a real time basis, based on preset commands, based upon the occurrence of a predetermined event, and/or in accordance with transmitted instructions or commands. The downloaded information is transmitted or broadcast to the remote location through a transmission link. The transmission link is preferably a direct satellite up/link-down/link, but the link also can be accomplished through a modem, a cell phone, radio frequency (RF), infrared, or any other means for transmitting information, as made available through advances in the relevant technology and as practiced in the art.

In another aspect of the invention, electronic access code and encryption keys are utilized to provide authorized access, and to prevent unauthorized access, to the information stored in the safe box of the Recording System. The downloading device has a limited access interface, such as a direct plug-in LED for example, for entering access codes or encryption keys to communicate with the Recording System. Once the access codes or encryption keys are received and accepted by the Recording System the device downloads the information and transfers the information onto a carrier wave for storage at a secure remote facility. In a preferred embodiment, the device re-encrypts the downloaded, de-encrypted information so that the information remains encrypted once it is downloaded, transmitted, and stored so that the integrity of the information is maintained and tampering is prevented. In a preferred embodiment, the device has a direct transfer, solid state repository, such as a flash memory, a hard disc drive, or the like, for allowing the download information to be stored at the remote storage facility.

In another aspect, the device has a video output interface to a display screen or monitor, such as an LCD display screen for example, so that a user can transport the remote information access and transfer device to the scene of an accident or crime, for example, to establish a remote, wireless communications link with the Recording System at the scene and to view the scene in real time and/or as it was recorded and stored by the Recording System. In this way, law enforcement, medical personnel, or other emergency and rescue personnel can view an incident occurring at a remote location, such as at the scene of an accident or a crime for example, while en route to the scene, while assistance is being rendered to a victim, or while a perpetrator is being pursued. Additional information pertaining to certain physical phenomena, such as vehicle speed, braking distance, time of the incident, audio recordings, and the like, can accompany the video output to permit rescue workers, medical personnel, and police officers, for example, to ascertain such things as the extent of any injuries, fault, the types of rescue devices required, and/or whether a suspected perpetrator is armed.

Other objects, features, and advantages of the present invention will become apparent to those skilled in the art from the following detailed description. It should be understood, however, that the detailed description and specific examples, while indicating preferred embodiments of the present invention, are given for purposes of illustration and not of limitation. Many changes and modifications within the scope of the present invention may be made without departing from the spirit thereof, and the invention includes all such modifications.

### BRIEF DESCRIPTION OF THE DRAWINGS

The above and further objects of the invention will become more readily apparent as the invention is more fully understood from the detailed description to follow, with reference being made to the accompanying drawings in which like reference numerals represent like parts throughout and in which:

FIG. 1 is a schematic illustration of the instant invention.

FIG. 2 is a component location in accordance with an exemplary embodiment of the instant invention.

FIG. 3 is a conceptual diagram of an exemplary embodiment of the system of the instant invention using a GPS up/link down/link system.

### DESCRIPTION OF EXEMPLARY EMBODIMENT

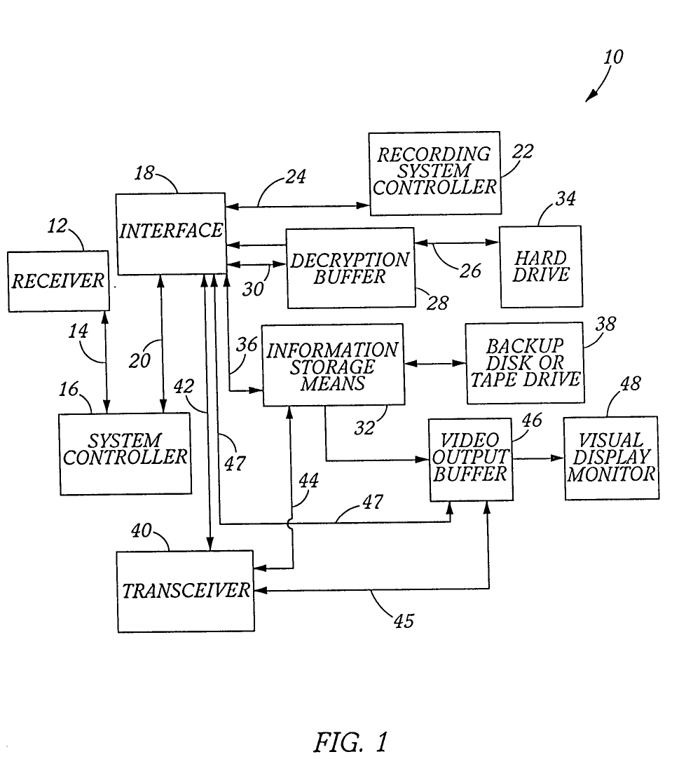

The downloading device of the instant invention 10 is shown in FIG. 1, which is a schematic only. The downloading device 10 is remotely located from the Recording System. The downloading device is preferably mounted in a police cruiser, rescue vehicle and the like. In a preferred embodiment, upon activation, a receiver 12 communicates with the system controller 16 via link 14 to request access codes and/or encryption keys. The system controller 16 communicates with interface 18 via link 20 to activate the transmission of the access codes or encryption keys to the Recording System controller 22 located on the Recording System via code access link 24 for verification. Upon receipt of the verification of access codes or encryption keys from the Recording System controller 22 via code access link 24 to the interface 18 and via link 20 to the system controller 16, the system controller 16 triggers the interface 18 to begin downloading the information from hard drive 34 located on the Recording System through information stream link 26. The interface 18 is directly connected to an decryption buffer 28 via information junction link 30 which can encrypt or decrypt the information stored on the hard drive 34.

As the interface 18 accesses the information stored on the hard drive 34 located on the Recording System, the information is encrypted or decrypted by the buffer 28, and then downloaded via information stream link 26. The interface 18 stores the information on the download device 10 by directly communicating with the download device's information storage means 32 via link 36. The information storage means 32, which has the capacity to store the information for 48 hours or more, records the encrypted or unencrypted information accessed by the interface 18. Hard disk storage is preferred for large capacity. Any configured hard disk device can be used for example, a Seagate UDMA 8.6 GB hard drive. Additionally tape drive storage can be used either as primary or backup. The information storage means 32 is controlled by the system controller 16 to activate the information storage means 32, play back recorded information, find referenced events, decode the stored information and the like. This permits authorities at the scene of an accident or crime to be in full control of the information storage means 32 located in the downloading device so that they may reconstruct and view information on sight or en route, and monitor any previous incident recorded by the Recording System. Preferably, the system controller 16 prohibits recording over a previously downloaded portion of the information, prior to the drive space being released to the device 10. In this manner a permanent, non-corrupted record is retained on the downloading device 10. The system controller 16 remembers the point on the disk where the prior recording was terminated and will index to that point on the disk, prior to the resumption of recording, in response to the activating of the downloading device 10. The information storage means 32 also communicates with a backup disc or tape drive 38 which provides for the information to be removed from or copied from the information storage means 32 either in encrypted or non-encrypted form onto a transferable tape or disk. The tape or disk can then be transported to another location, such as, for example, a hospital for viewing by medical personnel treating an accident victim.

The interface 18 also directly communicates with transceiver 40 via first transmission link 42. This interface allows real time transmission of data, simultaneously with storage. The transceiver 40 can comprise a direct satellite uplink, RF radio, modem, cell phone, or the like. In accordance with this embodiment, the transceiver 40 can receive remote signals which allows the interface 18 of the download device 10 to directly transmit the information simultaneously as it is being downloaded from the hard drive 34 located on the Recording System. The download device's information storage means 32 can also communicate with the transceiver 40 via transmitting link 44 so the information can be transmitted, via the transceiver 40, to a remote location after it is stored on the download device's information storage means 32. Additionally, the transceiver 40 can communicate with the Recording System directly in order to transmit the information in real time to an offsite location or directly to the video output buffer 46 via second transmission link 45 for viewing in real time, on the visual display monitor 48.

In operation, the system of the instant invention can operate in many modes from real time transmission to a remote location to transmission of stored information upon command. For example, a police officer, who is en route or arrives at the scene of an accident or vehicle theft can access the information pertaining to the incident stored in the safe box of the Recording System and watch a video replay at the scene by inputting access codes or encryption keys into the keyboard of the information transfer device. The codes will be transmitted to the Recording System by the interface. Upon their authentication, the downloading device will communicate with the Recording System in order to download the information onto the download device. The downloading device also communicates with a transceiver unit in order to transmit the information to an offsite location. The information can then be displayed via the video output interface onto a visual display screen. Attendant with recorded information displayed on the visual display screen may be information on such physical phenomena as the speed of the vehicle, brake distance, time of the accident, video information, etc. The information may thereafter be saved into the downloading device's information storage means.

In another aspect, the download device 10 will contain a unique encryption key that may be accessible by a remote station so that the transceiver 40 of the downloading device 10 can be activated remotely to start transmission download at any time from either the interface 18, the information storage means 32 or the hard drive 34.

The interface 18 also communicates directly via third transmission link 47 or via the information storage means 32 with a video output buffer 46. The video output buffer 46 is connected to a visual display monitor 48. The visual display monitor 48 is preferably a color LCD display but can be a CRT or other screen-type monitor. The visual display monitor 48 provides for the information downloaded from the information storage means 34 located on the Recording System to be viewed on the scene or en route by for example, authorities trying to apprehend a perpetrator or medical personnel trying to provide medical attention to an accident victim.

In another embodiment the information recorded from certain monitors and transducers located on the Recording System can be downloaded by the interface 18 from hard drive 34 located on the Recording System and superimposed on recorded video information also downloaded from hard drive 34 located on the Recording System. This additional information can be stored on the downloading device's 10 information storage means 32, on transferable disk or tape, transmitted to an off site location via transceiver 40 or can be transmitted along with the video signals via the video output buffer 46 and displayed on the visual display monitor 48.

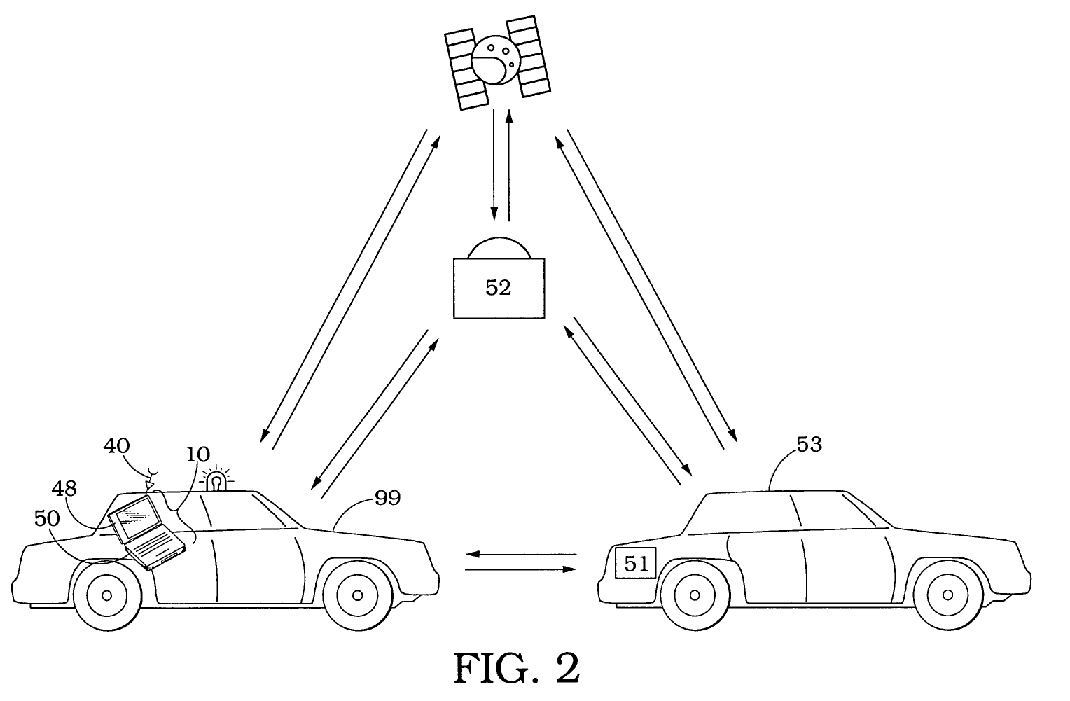

Turning to FIG. 2, there is shown a component location diagram in accordance with an exemplary embodiment of the instant invention. In this exemplary embodiment, the download device 10 is implemented in a form that is similar to that of a laptop computer with a visual display monitor 48 and keyboard 50. The download device 10 may be self-contained with, for example, a phone jack and/or a modem hooked to a mobile phone or SET for direct satellite transmission via transceiver 40. In the depicted embodiment, the Recording System 51 is located in a vehicle 53, and the download device 10 is located remotely from the Recording Systems 51 such as, for example, in a police cruiser 99. One with ordinary skill in the art appreciates that the download device 10 could also be located in a wide variety of other mobile locations, including an emergency vehicle such as a fire truck, ambulance or the like, or in a military vehicle such as a tank or helicopter, or in the vehicle of an insurance adjuster, or a fleet manager, or a site manager. Alternatively, the download device 10 could be implemented in a variety of packaging configurations to enhance its mobility, for example to be carried by hand or in a carrying case or even a napsack or a backpack. Of course, the download device 10 could also be implemented as a stationary fixture as well.

In the exemplary embodiment of FIG. 2 the download device 10 is activated to retrieve the vehicle information by a command entered via the keyboard 50 or alternatively, as a result of a transmission trigger from a Recording System 51. In an exemplary embodiment, the downloading transmission may be triggered by the occurrence of a predetermined event or series of events or even the failure of the occurrence of an event or series of events. Additionally, as one with ordinary skill in the art appreciates, a download may be triggered by satisfaction of, or the failure to satisfy, a variety of logical criteria relating to the vehicle or its surrounding environment and/or its contents including, for example, position, velocity, acceleration, direction, time, temperature, pressure, mechanical deformation, chemical presence or exposure, sound, proximity, conductivity or other electrical properties, magnetic or electromagnetic field strength or orientation or other magnetic or electromagnetic properties, or radioactivity, or any combination thereof.

Upon activation, the information, which can be recorded information and/or live information, can be transmitted from the Recording System 51 to a secure location 52 or, upon request, directly to the download device 10, which, in this case, is located in the police cruiser 99. Utilizing access codes, the download device 10 may alternatively retrieve the information from the Recording System 51 or the secure location 52. Further, one with ordinary skill in the art appreciates that the transmissions of 15 information in each case, whether from the Recording System 51 to the download device 10 or to the secure location 52, or from the secure location 52 to the download device 10, or from the download device 10 to the secure location 52, may be via tower, radio wave, satellite band width, or the like. As the information is downloaded, the monitor 48 can display the video information, and the download device 10 can play audio or other information as desired, either on the scene or en route to the scene or from any other desired vantage point chosen, for example, for safety or convenience or comfort. The transceiver 40 can also communicate directly with a Recording System 51 in order to transmit the information instantaneously, or in real time, to an off site location 52 through a transmitter or transceiver and/or via satellite 56 or other means which are readily understood by one skilled in the art.

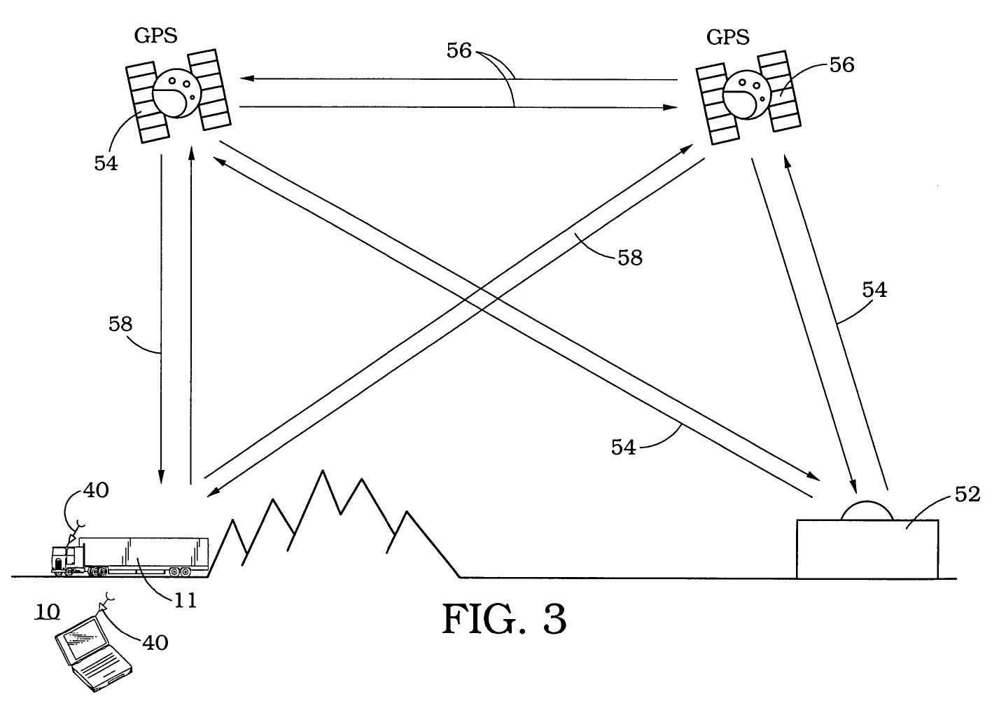

Referring to FIG. 3, there is shown the relationship between the GPS satellite system, and the transceiver 40 located on the downloading device 10 and transceiver 52 located at an off-site location. To inject information into the system, transceiver 52 up/links by mimicking the L3 link by transmitting a signal 54 in the VHF/UHF band to the nearest satellite 56 in view. The signal 54 is an anti-jam, frequency-hopped transmission. Upon reception, the satellite 56 dehops and demodulates the signal 52, reformats and remodulates signal 54 and then transmits the signal 58 on the L3 link at 1381.05 MHZ. The satellite also re-transmits the signal 58 on a cross-link to other GPS satellites in order to effect global coverage. Crosslinked transmission signals 58 are downlinked on L3 as well. Although the L3 link on the GPS navigation satellite system is contemplated as the best mode for communication between the transceiver 40 and the off site location or authorities, hospitals and the like, other satellite systems are also anticipated as functioning in place of the GPS satellites 56, with the transceiver 52 suitably modified.

The system and method of downloading the secure information of the present invention becomes indispensable with respect to the Secure, Vehicle Mounted, Surveillance System. Specifically, thieves gaining access to a vehicle may ferret out the on board safe box containing the stored information and remove it. Additionally, in cases of car jacking, the thieves have control of the vehicle as well as the Secure, Vehicle Mounted, Surveillance System, making the probability of recovery of the information stored on the vehicle slight. Additionally, the ability of the instant invention to receive in real time the circumstances surrounding a vehicle after the theft is invaluable to the safety of law enforcement personnel. For example, officers will be able to ascertain whether a perpetrator is still lurking around the vehicle and if any one is armed.

Another advantageous aspect of the instant invention is the ability to immediately download information, either from a Recording System or directly from an information source such as a sensor or video sensing element such as a CCD element or an audio sensor on the monitored vehicle or site, and to transmit a secure copy of the downloaded information, via a transceiver communicating with a satellite or the like, to an off site location for analysis by insurance adjusters and/or for use as evidence in court proceedings and/or for storage. In this manner, a repository of all information from various devices in various vehicles, including ones involved a simultaneous event, such as a multi-car accident, can be securely stored in a single repository accessible by authorities and insurance adjusters so that a particular incident can be “reconstructed” in a side-by-side or frame-by-frame manner. The information can also be stored onto the downloading device's information storage means and a copy made in the devices back up information storage means, such that a tape or disk can be made of the incident for transport to, for example, a hospital.

It will be realized that other information may be gathered, encoded and stored in the synchronized information system. For example, GPS tracking information or the like. In this manner hijacked vehicles can be tracked, recovered or the site of an accident located.

Although the present invention has been described with reference to preferred or exemplary embodiments, including particular materials and size parameters, those skilled in the art will recognize that various modifications and variations to the same can be accomplished without departing from the spirit and scope of the present invention and that such modifications are clearly contemplated herein. No limitation with respect to the specific embodiments disclosed herein and set forth in the appended claims is intended nor should any be inferred.

1-71. (canceled)

72. A remote information downloading device for wireless access to and downloading of vehicle information from a remote, on-board, vehicle incident recording system, the downloading device comprising:
a) at least one interface communicating with and accessing and receiving incident data from the vehicle incident recording system;
b) an information datalink coupled to said interface for transferring said received incident data from said interface; and
c) a transceiver coupled to said information datalink for accessing, receiving, downloading, and transmitting said vehicle information from the vehicle incident recording system,
wherein said interface is a transceiver that includes a download trigger for initiating downloading of information from said recording system.

73. The device of claim 72 further including an information storage device coupled to said vehicle incident recording system for capturing and storing said vehicle information.

74. The device of claim 73 wherein said information storage device is selected from the group consisting of a video tape drive, a hard disk drive, a CD ROM drive, and a solid state repository.

75. The device of claim 74 wherein said information storage device is adapted to prevent said vehicle information from being overwritten for extended periods of time.

76. The device of claim 72 wherein said vehicle information comprises identification information.

77. The device of claim 72 wherein said vehicle information comprises video information.

78. The device of claim 72 further comprising playing means for displaying said vehicle information.

79. The device of claim 78 wherein said playing means comprises a visual display.

80. The device of claim 79 wherein said visual display is adapted for viewing video information.

81. The device of claim 79 wherein said visual display comprises a visual output interface to a display screen.

82. The device of claim 79 wherein said visual display comprises an off-board visual output interface.

83. The device of claim 72 wherein said vehicle information comprises audio information.

84. The device of claim 78 wherein said playing means is adapted for playing audio information.

85. The device of claim 72 wherein said vehicle information comprises time information.

86. The device of claim 72 wherein said vehicle information comprises vehicle dynamic information.

87. The device of claim 72 wherein said vehicle information comprises vehicle control information.

88. The device of claim 72 wherein said download trigger is adapted to respond to the occurrence of a predetermined event.

89. The device of claim 72 wherein said download trigger is adapted to respond to transmitted instructions.

90. The device of claim 72 wherein said download trigger is adapted to require input of an electronic access code.

91. The device of claim 72 wherein said transceiver is adapted to download encrypted information from said recording system.

92. The device of claim 91 wherein said device is further adapted to decrypt said information.

93. The device of claim 74 wherein said information storage device is remotely located from said vehicle.

94. The device of claim 72 wherein said transceiver is adapted to transmit information to an off-site location.

95. The device of claim 94 wherein said transceiver provides a transmission link.

96. The device of claim 95 wherein said transmission link is a direct satellite up-link/down-link.

97. The device of claim 94 wherein said transceiver provides a transmission trigger for initiating transmission of information to an information storage device.

98. The device of claim 97 wherein said transmission trigger is adapted to respond to the occurrence of a predetermined event.

99. The device of claim 97 wherein said transmission trigger is adapted to respond to transmitted instructions.

100. The device of claim 72 wherein said device is adapted for use in a vehicle.

101. The device of claim 100 wherein said vehicle is selected from the group consisting of a police cruiser, an ambulance, a fire truck, and a rescue vehicle.

102. The device of claim 72 wherein said device is adapted for use in a stationary facility.

103. The device of claim 102 wherein said facility is selected from the group consisting of a hospital, a police station, and a fire station.

104. The device of claim 72 wherein said interface is a limited access interface.

105. A method for remotely accessing and downloading stored information from a recording system located on a vehicle, comprising the steps of:
a) remotely activating a downloading device having an interface for accessing and downloading said stored information from said recording system,
b) receiving and playing said downloaded information; and
c) displaying said played information.

106. The method of claim 105, said information comprising vehicle identification information.

107. The method of claim 105, said information comprising video information.

108. The method of claim 105, said information comprising audio information.

109. The method of claim 105, said information comprising time information.

110. The method of claim 105, said information comprising vehicle dynamic information.

111. The method of claim 105, said information comprising vehicle control information.

112. The method of claim 105, including the steps of transmitting said information to an off-site location.

113. The method of claim 112, said transmitting performed via a transmission link.

114. The method of claim 113 wherein said transmission link is a satellite up-link/down-link.

115. The method of claim 105, including capturing and storing said information.

116. The method of claim 115, including storing said information remotely.

117. The method of claim 115, including capturing and storing said information to a device selected from the group consisting of video tape, a hard disk, a CD ROM, and a solid state repository.

118. The method of claim 115, including temporarily preventing said information from being overwritten.

119. The method of claim 105, including inputting an electronic access code.

120. The method of claim 105, including encrypting said information.

121. The method of claim 120, including decrypting said information.
